(19) United States
(12) Patent Application Publication
(10) Pub. No.: US 2007/0143693 A1
(43) Pub. Date: Jun. 21, 2007

(54) Method of managing bulletin of internet and a system thereof

(75) Inventors: Mi Jeong Choi, Seoul (KR); Hye Kyung Kim, Seoul (KR)

Correspondence Address: MCDERMOTT WILL & EMERY LLP, 600 13TH STREET, N.W., WASHINGTON, DC, 20005-3096, US

(73) Assignee: NHN CORPORATION, Seoul (KR)

(21) Appl. No.: 10/575,897

(22) PCT Filed: Oct. 16, 2004
(86) PCT No.: PCT/KR04/02657

§ 371 Date: Apr. 14, 2006

(30) Foreign Application Priority Data
Oct. 16, 2003 (KR) 10-2003-0072287

(51) Int. Cl. G06F 15/16

(52) U.S. Cl. 715/753; 715/733; 709/201

(57) ABSTRACT

The present invention relates to a method of managing a bulletin board on the Internet and a system thereof. More particularly, the present invention relates to a method of managing a bulletin board on the Internet and system thereof, wherein the bulletin board is generated and operated so that a plurality of bulletin board users may publish one's own professional knowledge on one subject.

### TECHNICAL FIELD

The present invention relates to a method of managing a bulletin board on the Internet and a system thereof. More particularly, the present invention relates to a method for managing a bulletin board on the Internet and system thereof, wherein the bulletin board is generated and operated so that a plurality of bulletin board users may publish one's own professional knowledge on one subject.

### BACKGROUND ART

A conventional search engine, such as Altavista (http.//www.altavista.com), Lycos (http://www.lycos.com) or Yahoo (http://wwwyahoo.com), generally includes a database for classifying, storing and managing web site information based on a predetermined rule, a search robot, embodied as software, for constantly traveling over the web and automatically collecting new web site information, and search engine software for storing the collected data in a database and allowing a user of the search engine to search for desired information in the database.

Recent search service providers enable the user to directly write one's own opinion or answer on various issues on the Internet, not mechanically collecting and providing webpage information through the conventional search robot, whereby a method of building predetermined information's pool through the user's direct participation is becoming common. A service using the aforementioned method of the user's direct participation, named as a knowledge search service, is being widely used step by step, based on Naver (www.naver.com), Daum (www.daum.net), or Empas (www.empas.com).

The knowledge search service like above is esteemed greatly in the aspect that it is the service that users can share their own experience ox knowledge obtained from all the sources offline with other users on the Internet. Moreover, users of the service increase exponentially. The knowledge search service is performed in a way that in case that a questioner asks a question on the Internet, an answerer who knows the question gives an answer. In addition, it is operated in a way that the user having the same or a similar question can search for and obtain one's desired knowledge easily by strong the question and the answer in a knowledge search database means.

Since a conventional knowledge search service based on a questioner-answerer has at least one answerer or two or three answerers at most, there is a problem that levels of answers to the question are not so high. Namely, since it is a fragmentary answer, although the user who has the same or a similar question reads the answer, in some cases, it is not the user's desired answer to the question. Accordingly, in case that a questioner searches for preceded questions with respect to the question that the questioner wants to ask, the questioner may find many same or similar questions, but may not find one's desired answer. In addition, since the same or similar questions are too many, value of information may be reduced to a half. This is caused by a structural limit of the knowledge search service based on the questioner-answerer. Therefore, the smaller the number of questioners or answerers is, the bigger the aforementioned problem becomes.

Accordingly, there has been desired for the knowledge search service which can provide more profound and specialized contents on the specified subject

### BRIEF DESCRIPTION OF THE DRAWINGS

FIG. 1 is a flowchart illustrating a method for opening a bulletin board on the Internet according to one preferred embodiment of the present invention.

FIGS. 2a to 2c are flowcharts illustrating detailed procedures which may be performed in a method of opening a bulletin board on the Internet as illustrated in FIG. 1.

FIGS. 3a to 3c are flowcharts illustrating one example of a user interface which may be adopted in a method for opening a bulletin board on the Internet according to one embodiment of the present invention.

FIG. 4 is a flowchart illustrating a method for operating a bulletin board on the Internet according to one preferred embodiment of the present invention.

FIGS. 5a to 5d are flowcharts illustrating detailed procedures which may be performed in & method of operating a bulletin board on the Internet as illustrated in FIG.4.

FIGS. 6a to 6c are views illustrating one example of a user interface which may be adopted in a method for operating a bulletin board on the Internet according to one embodiment of the present invention.

FIG. 7 is a block diagram illustrating configuration of a system for managing a bulletin board on the Internet according to one embodiment of the present invention.

### DISCLOSURE OF THE INVENTION

Technical Questions

A method and system for managing a bulletin board on the Internet according to the present invention is conceived to solve the aforementioned problems in the prior art.

Therefore, it is one object of the present invention to complete contents of knowledge through a plurality of users' cooperation, not one user's knowledge, by helping at least one bulletin board user to input contents of knowledge on a specified subject in various points of views.

Further, it is another object of the present to provide a new knowledge search service method which enables a plurality of users to read knowledge data, wherein one knowledge data is built by helping a plurality of bulletin board users to fill the knowledge data on one subject, and stored in a database.

Furthermore, it is another object of the present invention to provide a knowledge search, service on various fields by inducing a new category based on a user, not classification of categories which is provided by a conventional knowledge search service.

Technical Solutions

In order to achieve the aforementioned objects, according to one aspect of the present invention, there is provided a method for generating a bulletin board on the Internet, comprising the steps of maintaining a bulletin board database storing at least one bulletin data -which at least one user has input on the unitary subject; providing a user interface for receiving data required to open the bulletin board, for an establisher, a user who wants to open the bulletin board; receiving application data of the bulletin board tom the establisher; transmitting the received application data to a bulletin board operator; notifying the establisher that the bulletin board has been generated in accordance with approval of the bulletin board operator; and recording the application data for the generated bulletin board in the bulletin board database; wherein the application data comprises at least one selected from a group consisting of subject data of the bulletin board, information on the number of the bulletin data which is possible to be registered on the bulletin board, and information on an expiration date of the bulletin board.

Furthermore, according to another aspect of the present invention, there is provided a method for operating a bulletin board on the Internet, comprising the steps of receiving bulletin data related to subject data of the bulletin board from one or more bulletin board users including the establisher of the bulletin board; determining whether or not the bulletin data may be registered by analyzing the same; closing the bulletin board, based on a predetermined criterion, wherein the predetermined criterion is set based on information of the number of bulletin data which is possible to be registered on the bulletin board, or the expiration date of the bulletin board that the establisher has input when the bulletin board is generated; transmitting bulletin material information, including the bulletin data of the closed bulletin board, to the bulletin board operator; notifying the establisher that the bulletin board has been completed in accordance with approval of the bulletin board operator; and recording the bulletin material information on the closed bulletin board in the bulletin board database.

### BEST MODE FOR CARRYING OUT THE PRESENT INVENTION

Hereinafter, a method and system for managing a bulletin board on the Internet according to the present invention will be in detail described with reference to the accompanying drawings.

A bulletin board according to the present invention may be operated in such a way that one or more users register bulletin data related to at least one knowledge content on a specified subject, on the Internet by relays. Namely, the present invention may be embodied in such a way that a bulletin board establisher assigns a subject of bulletin data or the number thereof to be registered on the bulletin board and at least one bulletin board user inputs bulletin data by relays according to the assigned subject of bulletin data or number thereof.

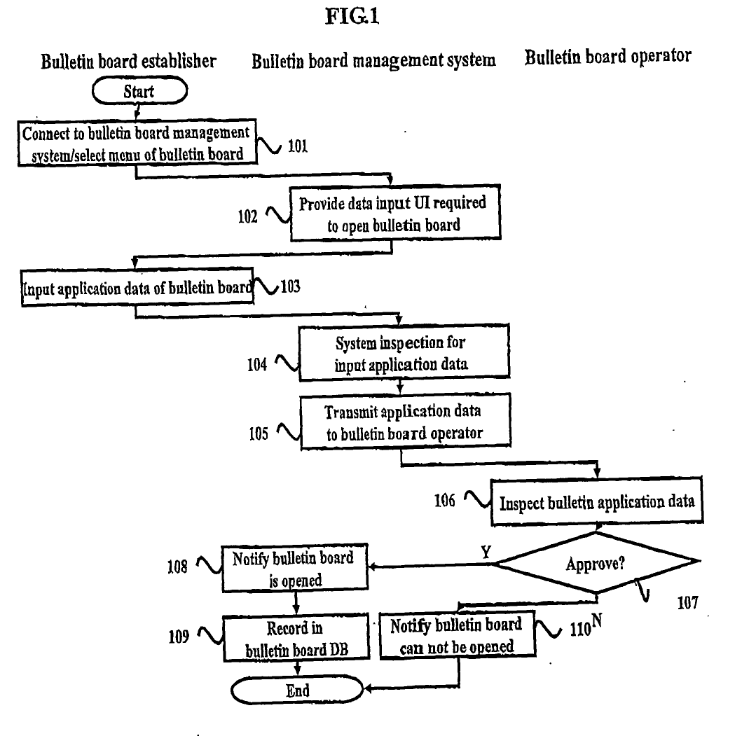

FIG. 1 is a flowchart illustrating a method for opening a bulletin board on the Internet according to one preferred embodiment of the present invention.

Referring to FIG. 1, a bulletin board establisher who wants to open a bulletin board according to the present invention connects to a bulletin board management system according to the present invention and selects a menu related to the bulletin board (step 101). The bulletin board management system provides the bulletin board establisher with a user interface for receiving predetermined data required to open the bulletin board (step 102). The bulletin board establisher inputs application data of the bulletin board in a bulletin board database, wherein the application data comprises subject data of the bulletin board related to the subject of the bulletin board that the establisher wants to open, predetermined category information related to the subject of the bulletin board, information on the number of the bulletin data to be registered on the bulletin board, or information on an expiration date of the bulletin board about the period for which the bulletin board is operated (step 103).

The bulletin board management system according to the present invention receives the input application data, classifies subject data, category information, information on the number of bulletin data, or information on the expiration date comprised in the application data, by each field thereof and performs system inspection (step 104). System inspection performed in the step 104 may include the following methods.

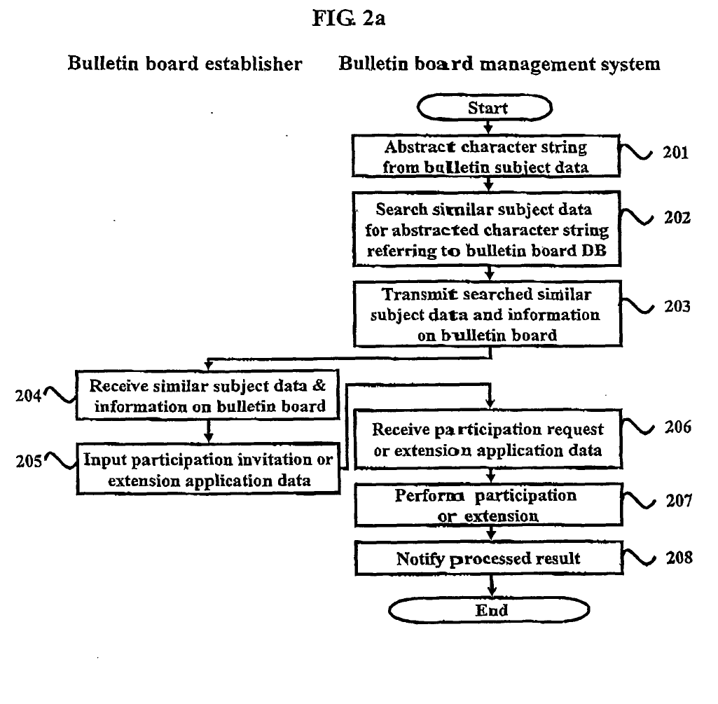

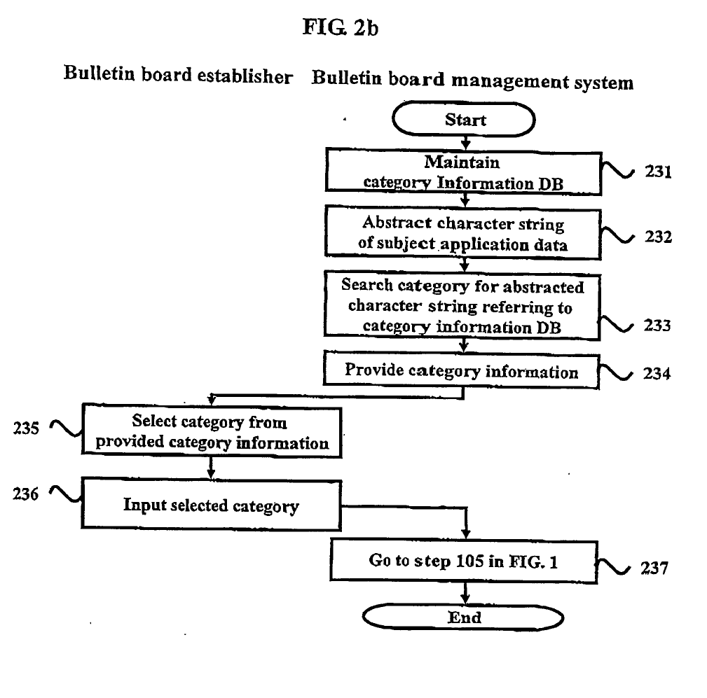

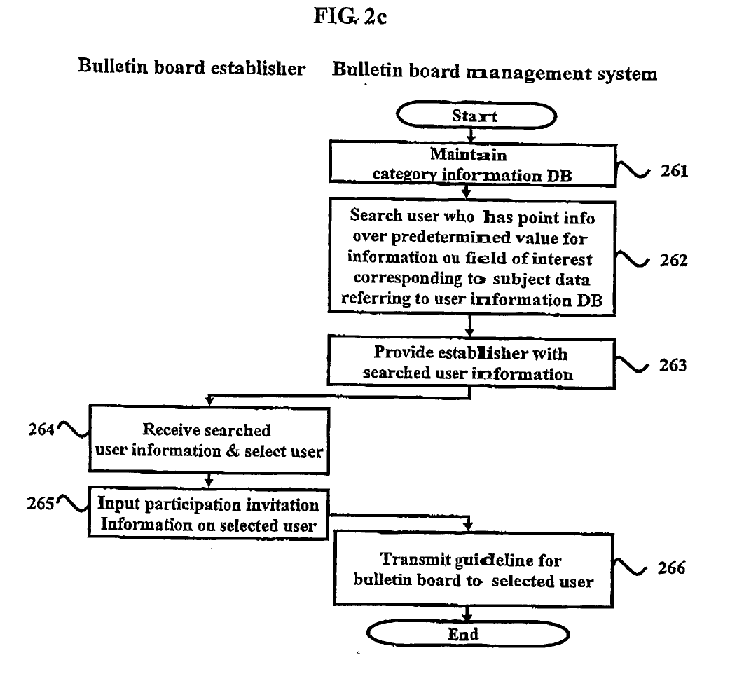

(1) The bulletin board management system according to the present invention can search for preceded bulletin board information with respect to the same or similar subject to the subject data of the bulletin board. The bulletin board management system includes a bulletin board information database storing a plurality of bulletin board information and searches for preceded bulletin board information stored therein, based on the application data that the bulletin board establisher has input in the step 103. A flow of the preceded bulletin board information search like above will be in detail described with FIG. 2a described later.

(2) The bulletin board management system according to the present invention may be operated to sort a subject which goes against good public order and morals, through abstract of character strings for the subject data. Namely, the bulletin board management system may be performed by abstracting character strings for the subject data input by the bulletin board establisher and by determining whether there is any same or similar key word to a record-prohibited keyword (e.g., a key word in relation to adult things, abuse, advertisement and the lice) recorded in a keyword database, among the abstracted character sits For subject data including the record-prohibited keyword, a message informing that application of the bulletin board is prohibited may be provided for the bulletin board establisher through a user interface, a type of popup window.

(3) The bulletin board management system according to the present invention may be operated to prohibit the bulletin board establisher whose point information is below a predetermined value, based on predetermined point information (numerical points based on previous activity history of the user who wants to open the bulletin board) from opening the bulletin board. Namely, the bulletin board management system includes a user information database storing point information that is given to the bulletin board user according to a predetermined criterion or information on the bulletin board user (a user ID, field of interest, or contact information) and searches for the point information of the bulletin board establisher by referring to the user information database. In case that the point information of the bulletin board establisher is below the predetermined value, a message informing that application of the bulletin board is prohibited may be provided for the bulletin board establisher through the user interface in a type of a popup window.

After performing the aforementioned system inspection, the bulletin board management system according to the present invention transmits the application data of the bulletin board to the bulletin board operator (step 10). The bulletin board operator is an entity who manages the bulletin board generated and operated according to the present invention. Therefore, the bulletin board operator may be located inside the bulletin board management system according to the present invention or manage the bulletin board via a predetermined communication network by locating oneself in a remote location of the bulletin board management system. The bulletin board operator inspects the transmitted application data (step 106), determines whether or not the application data satisfies the predetermined criterion (step 107) and approves application of opening the bulletin board for the application data. Inspection of the bulletin board operator performed in the steps 106 and 107 may be performed, based on 1) adequacy of the subject date of the bulletin board or 2) adequacy of category information.

In case that the bulletin board operator approves application of opening the bulletin board in the step 107, a response of approval is transmitted to the bulletin board management system. And the bulletin board management system notifies the bulletin board establisher that the bulletin board has been opened (step 108). The step 108 may be performed by sending a SMS informing that the bulletin board has been opened to the bulletin board establisher e-mail or mobile communication device. In case that the bulletin board is opened, information included in the application data is recorded in the bulletin board database (step 109). In case that the bulletin board operator disproves application of opening the bulletin board in the step 107, i.e. in case that the application is determined to be unsuitable, a message informing that application of opening the bulletin board has been withdrawn due to a predetermined reason is transmitted to the bulletin board establisher (step 110).

The bulletin board according to the present invention may be generated through steps 101 to 110.

FIGS. 2a to 2c are flowcharts illustrating detailed procedures which may be performed in a method of opening a bulletin board on the Internet as illustrated in FIG. 1.

FIG. 2a is a flowchart illustrating one example of a method for providing a bulletin board establisher with the same or similar preceded subject data of the bulletin board to the subject data thereof, in a method of generating a bulletin board according to the present invention.

The bulletin board management system according to the present invention abstracts character strings for -the subject data included in the application data input in step 103 of FIG. 1 (step 201). The bulletin board management system searches for the same or similar subject data corresponding to the abstracted character strings by referring to the bulletin board database (step 202) and provides the bulletin board establisher with the searched preceded subject data or information on current state of the bulletin board (e.g., information on the bulletin board in progress or the expiration date of the bulletin board) (step 203). The bulletin board establisher receives the provided preceded subject data or information on current state of the bulletin board (step 204). At this time, in case that the corresponding bulletin board is in progress, the bulletin board establisher may input participation request data or in case that the bulletin board has ended, may input extension application data for the bulletin board (step 205). In case that the bulletin board establisher can read the preceded subject data and obtain one's desired information in the step 205, application of opening the bulletin board may be withdrawn.

The bulletin board management system receives the participation request data or the extension application data input in the step 205 (step 206) and in case that the corresponding bulletin board is in progress, provides a user interface related to the bulletin board for the bulletin board establisher according to the received participation request data, and in case that the corresponding bulletin board has ended, performs procedures required to process extension of the bulletin board, according to the received extension application data (step 207). A result performed in the step 207 is re-notified to the bulletin board establisher (step 208). According to one embodiment of the present invention, in case that the bulletin board is extended by performing the procedures in the step 207, previous bulletin data registered for the corresponding bulletin board may be embodied so that correction or deletion thereof is impossible. This is to secure permanence of the bulletin board which has ended, by protecting previous bulletin data. In addition, this is also to encourage quality of bulletin data to be improved continuously, by preventing the bulletin board user who has applied extension of the corresponding bulletin board from changing contents thereof optionally.

FIG. 2b is a flowchart illustrating one example of a method for automatically providing the bulletin board established with predetermined category information related to subject data of the corresponding bulletin board, in a method of generating the bulletin board according to the present invention,

The bulletin board management system according to the present invention further comprises a category information database storing information on categories classified by a predetermined criterion (step 231). The bulletin board management system abstracts a character string for subject data included in tie application data input in the step 103 of FIG. 1 (step 232). The bulletin board management system searches for the same or similar category information corresponding to the abstracted character string by referring to the category information database (step 233) and provides the searched category information for the bulletin board establisher (step 234). The bulletin board establisher receives the category information provided in the step 234 and selects a category which has the highest relevance with the subject of the bulletin board that the bulletin board establisher wants to open, from the received category information (step 235). The bulletin board establisher inputs the selected category on a predetermined user interface (step 236). And a procedure of the step 105 in FIG. 1 is performed by transmitting the input category to the bulletin board management system.

FIG. 2c is a flowchart illustrating one example of a method for recommending an expert regarding the subject data to the bulletin board establisher, in a method of generating a bulletin board according to the present invention, wherein the method may be performed with notification of -the bulletin board.

The bulletin board management system according to the present invention comprises a user information database storing information on a bulletin board user (a user ID, field of interest or contact information) or point information given thereto according to a predetermined criterion (step 261). The bulletin board management system searches for a user whose point information is over a predetermined value for information on a field of interest corresponding to the subject data by referring to the user information database (step 262). And the bulletin board management system provides the searched user information for the bulletin board establisher (step 263). The bulletin board establisher receives the user information provided in the step 263 and selects a user whom the bulletin board establisher wants to request to participate into the bulletin board, from the received user isolation (step 264). The bulletin board establisher inputs the participation request information for the selected user on the predetermined user interface (step 265). The input participation request information is transmitted to the selected user with a guideline of the bulletin board (step 266). The participation request information or the guideline may be transmitted via an e-mail or SMS. In the step 265, in case that the selected user participates in the bulletin board, the participation request information may include a predetermined point that can be given to the user. Like above, participation of users can be improved by giving a predetermined point to the users.

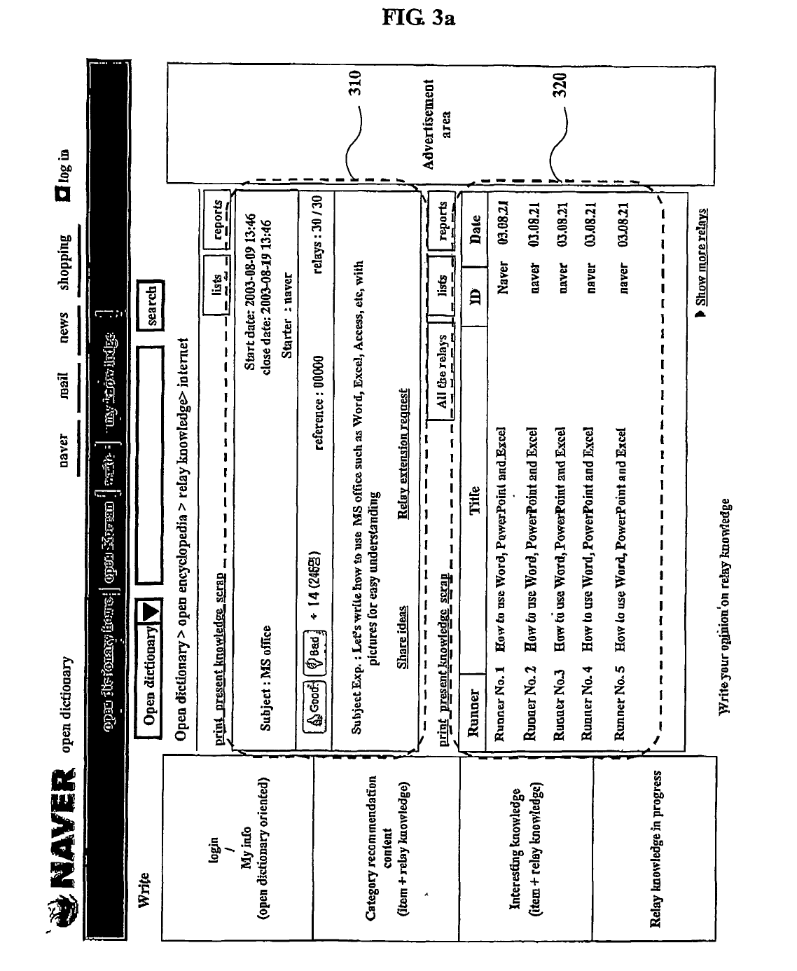

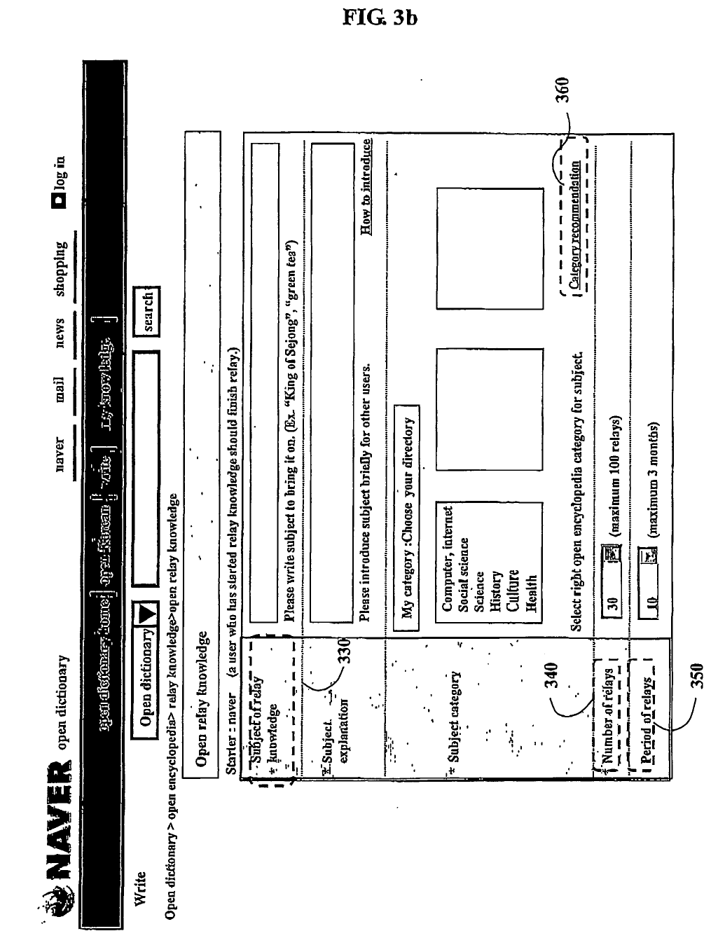

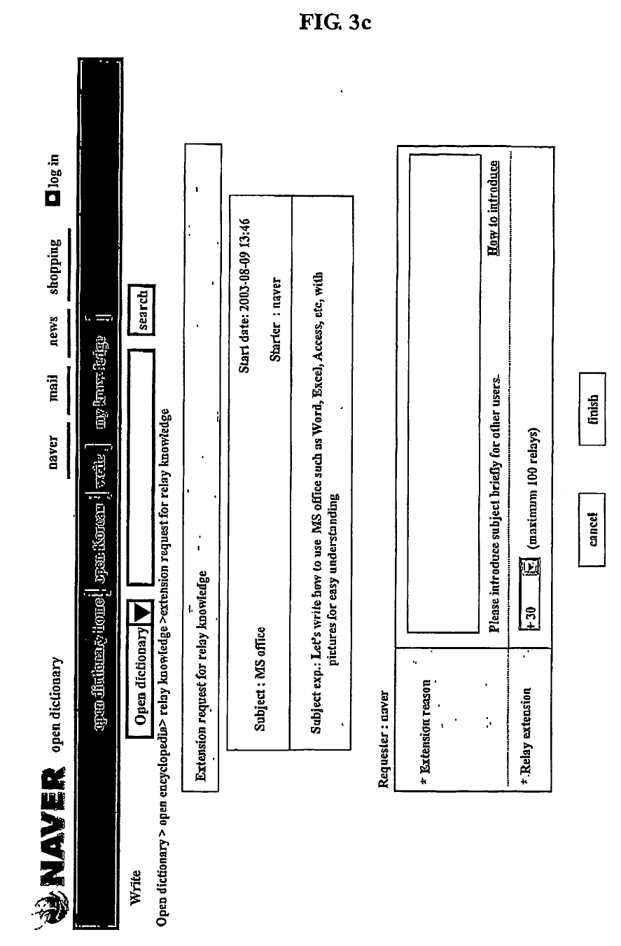

FIGS. 3a to 3c are drawings illustrating one example of a user interface which may be adopted in a method for opening a bulletin board on the Internet according to one embodiment of the present invention.

FIG. 3a is one example of a user interface for providing bulletin board users with information on the generated bulletin board according to the present invention.

Referring to FIG. 3a, the user interface for displaying bulletin board information may generally comprise an a-ea 310 of displaying subject data of the bulletin board and explanation data for the subject thereof and an area 320 of displaying a progress state of the present bulletin board and bulletin data registered thereon. The area corresponding to drawing symbols 320 can be embodied to be updated in real time whenever bulletin data registered on the corresponding bulletin board increases. A user who wants to read the bulletin board may read bulletin data that bulletin board users have input, by clicking the title (which may be displayed in a hyperlink) of the area 320.

FIG. 3b is one example of a user interface provided for a user who wants to open the bulletin board, for inputting application data of the bulletin board, in a method of generating the bulletin board on the Internet according to the present invention. Referring to FIG. 3b, a field of inputting the application data may comprise all area 330 of displaying subject data, an area 340 of displaying the number of bulletin data, or an area 350 of displaying an expiration date of the bulletin board. In addition, the application data may further comprise category information corresponding to the subject of the bulletin board or explanation data for the subject thereof. In case that the bulletin board establisher clicks an area 360 of displaying “category automatic recommendation” which is included in an area of setting the subject category of FIG. 3b, the aforementioned method in FIG. 2 may be performed. The aforementioned area 330 is an area for briefly inputting the subject that the bulletin board establisher wants to share on the bulletin board. The aforementioned area 340 is an area for entering the number of the bulletin data to be registered on the bulletin board. The aforementioned area 350 is an area for inputting the expiration data of the bulletin board. In the present embodiment, the expiration date of the bulletin board is required to be input, which may be one way to encourage bulletin board users to register bulletin data by setting the expiration date of the bulletin board. According to another embodiment of the present invention, the expiration date of the bulletin board can be omitted. In this case, in case that the number of bulletin data reaches a predetermined value, the bulletin board may be expired.

FIG. 3c is one example of a user interface for inputting extension application data in order to reopen the bulletin board after the bulletin board according to the present invention is expired. Referring to FIG. 3c, extension application data of the bulletin board may comprise bulletin board information including subject information of the corresponding bulletin board, information on a starting date thereof or information on an establisher thereof, and information on a user who has applied extension of the bulletin board, the reason of extension and the number of bulletin data which the user wants to extend. According to another embodiment of the present invention, it is also possible to perform extension application in connection with the expiration date of the bulletin board as well as the number of bulletin data. According to one embodiment of the present invention, as illustrated in FIG. 2, in case that a bulletin board establisher finds a preceded bulletin board which has the same or similar subject to the bulletin board that the bulletin board establisher wants to open, the extension application may be performed. In case that an existing bulletin board establisher wants to extend the closed bulletin board, or in case that a new bulletin board user wants to record more bulletin data by extending the same, the extension application may be performed. According to one preferred embodiment of the present invention, even in case that the closed bulletin board is re-opened in such a way that the extension application is approved, the present invention may be embodied not to permit correction of the existing bulletin data that has been registered, or deletion thereof.

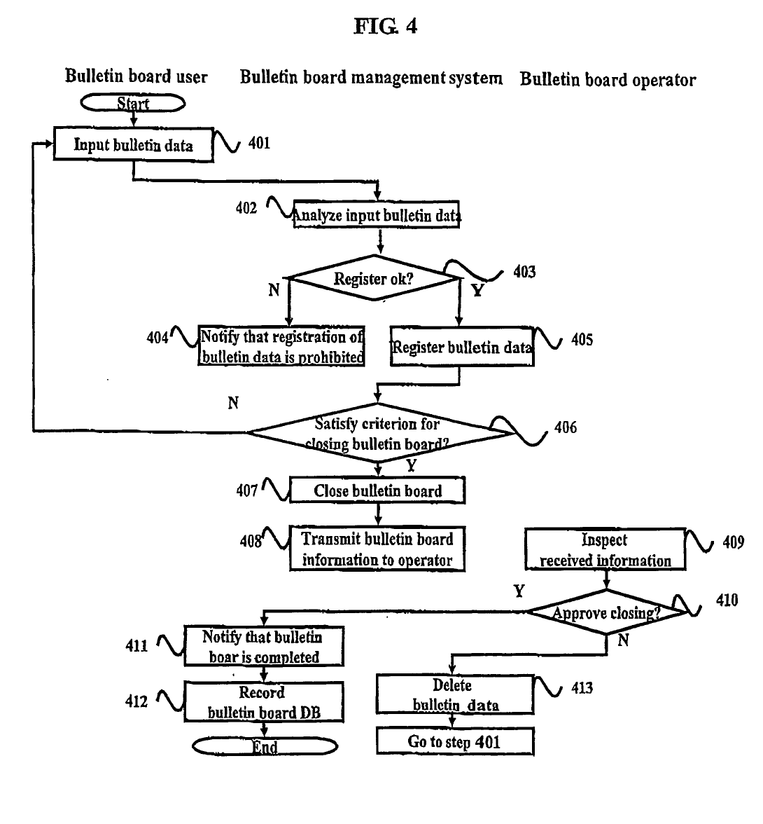

FIG. 4 is a flowchart illustrating a method for operating the bulletin board on the Internet according to one preferred embodiment of the present invention,

Referring to FIG. 4, the method for operating the bulletin board on the Internet according to the present invention may comprise the following steps. The bulletin board, object of the method for operating the bulletin board as illustrated in FIG. 4, may be one generated through the method aforementioned in FIG. 1.

At least one bulletin board user including the bulletin board establisher inputs bulletin data with respect to subject data on the bulletin board (step 401). The input bulletin data is transmitted to the bulletin board management system. The bulletin board management system receives the bulletin data and analyzes the same (step 402).

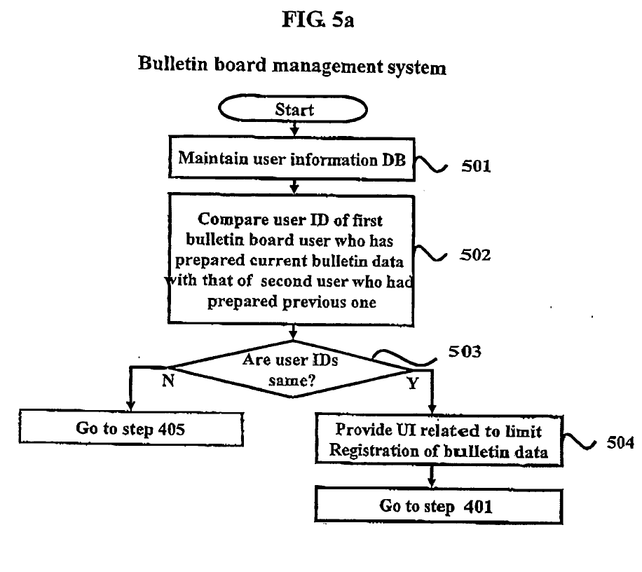

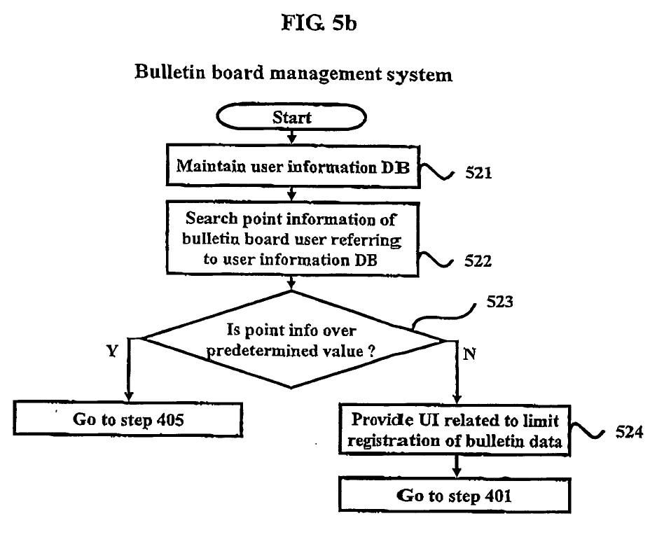

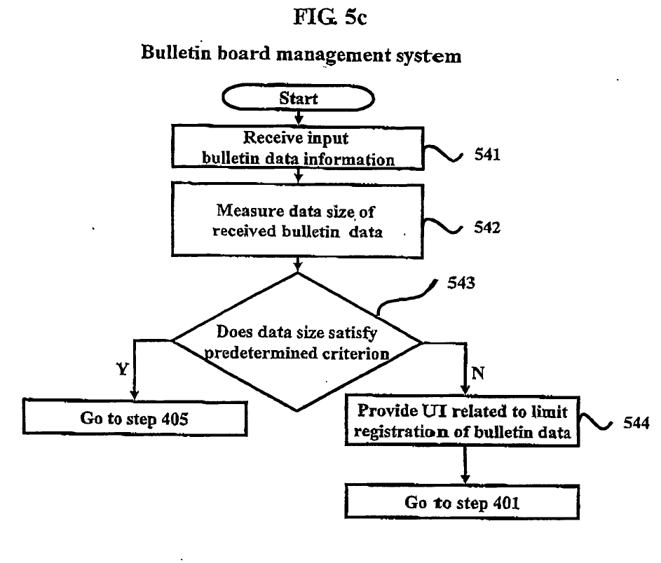

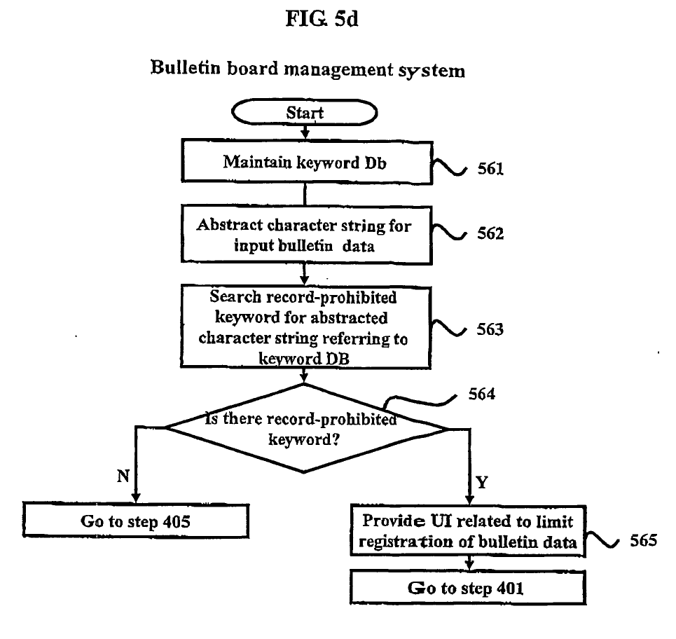

Analysis of the bulletin data of the bulletin board management system performed in the step 402 may be performed in a way as illustrated in FIGS. 5a to 5d.

FIGS. 5a to 5d are flowcharts illustrating one example of a method of analyzing bulletin data, wherein the method may be performed in a method for operating a bulletin board on the Internet as illustrated in FIG. 4.

FIG. 5a is a flowchart illustrating one example of a method of prohibiting a bulletin board user from inputting bulletin data consecutively in the step 402 of FIG. 4. Referring to FIG. 5a, the bulletin board management system according to the present invention comprises a user information database storing information on a bulletin board user (a user ID, field of interest, or contact information) (step 501). The bulletin board management system searches for a user ID of a second bulletin board user that had input bulletin data just before and for a user ID of a first bulletin board user that input bulletin data just now by referring to the user information database and compares two users' user IDs (step 502). The bulletin board management system determines whether or not two user IDs are identical (step 503) and in case that it is determined that two user IDs are identical, provides the first bulletin board user with the user interface including that registration of bulletin data input now is prohibited (step 504). In case that it is determined that two user IDs are different, a procedure of registration may be performed by returning, to the step 405 of FIG. 4. The method illustrated in FIG: Sa is for preventing one bulletin board user from inputting bulletin data exclusively. According to the present embodiment, the same bulletin user is prohibited from inputting bulletin data consecutively. However, it does not mean that bulletin data is input only once on one bulletin board.

FIG. 5b is a flowchart illustrating one example of a method of limiting a bulletin board user who wants to register bulletin data in step 402 of FIG. 4, to a user whose point information exceeds a predetermined value. Referring to FIG. 5b, the bulletin board management system according to the present invention comprises a user information database storing the information on the bulletin board user or predetermined point information given to the bulletin board user based on the predetermined criterion (step 521). The bulletin board management system searches for point information given to the bulletin board user by referring to the user information database (step 522) and determines whether or not the searched point information exceeds a predetermined value (step 523). In case that the point information of the bulletin board user is below the predetermined value, the user interface including that registration of bulletin data is prohibited is provided (step 524). In case that it is determined that the point information of the bulletin board user exceeds the predetermined value in step 523, procedures of registration of bulletin material may be performed by returning to the step 405 of FIG. 4.

FIG. 5c is a flowchart illustrating one example of a method of limiting a data size of bulletin data to a certain size in step 402 of FIG. 4. Referring to FIG. 5c, the bulletin board management system receives bulletin data input in the step 401 of IC 4 (step 541) and measures the data size of the received bulletin data (step 542). The bulletin board management system determines whether or not the data size measured in the step 542 satisfies the predetermined maximum/minimum condition (e.g., bulletin data is established to have the size thereof between 2 KB and 10 KB) (step 543). In case that it is determined that the size of the bulletin data does not satisfy the predetermined criterion, the user interface including that registration of bulletin data is prohibited is provided (step 544). In case that it is determined that the size of the bulletin data satisfies the predetermined criterion, procedures of registration of bulletin material may be performed by returning to step 405 of FIG. 4.

It is possible to prevent bulletin data from being poor or to prevent one bulletin board user from sending up too many writings, by enabling bulletin data satisfying the certain size condition to be selectively registered through the aforementioned method in FIG. 5c.

FIG. 5d is a flowchart illustrating one example of a method of prohibiting registration of bulletin data, in case that bulletin data includes a predetermined character string whose registration is prohibited, in the step 402 of FIG. 4, Referring to FIG. 5d, the bulletin board management system according to the present invention comprises a keyword database storing a selected record-prohibited keyword (e.g., a keyword which goes against good public order and morals) (step 561). The bulletin board management system abstracts a character string for bulletin data input in the step 401 of FIG. 4 (step 562) and searches for any record-prohibited keyword for the abstracted character string by referring to the keyword database (step 563). The bulletin board management system determines whether or not any record-prohibited keyword is included (step 564) and in case that it is determined that the record-prohibited keyword corresponding to the abstracted character string is stored, provides the user interface including that registration of the bulletin data is prohibited (in step 565). According to embodiments, a new user interface can be provided so that the corresponding bulletin data may be newly prepared or so that a character string corresponding to the record-prohibited keyword may be corrected after the step 565. In case that it is determined that any record-prohibited keyword is not included in the bulletin data in the step 564, procedures of registration of bulletin material may be performed by returning to step 405 of FIG. 4.

The bulletin board management systems according to the present invention may censor subject data of the bulletin board systematically through the method illustrated in FIG. 5d. Namely, there is an effect that the present invention may improve quality of bulletin data by systematically preventing adult things, abuse or advertisement from being included therein. In addition, an additional procedure may be performed in association with a bulletin board user who has input bulletin data including the record-prohibited keyword, by reducing point information of the corresponding bulletin board user or depriving the right thereof to participate in the corresponding bulletin board.

Bulletin data satisfying procedures of the system inspection of FIGS. Sa to 5d as described above is registered (step 405). For bulletin data unsatisfying a predetermined criterion, a notice informing that registration of the corresponding bulletin data is prohibited is transmitted to the bulletin board user who has input the bulletin data (step 404). The step 404 is same to steps 504, 524, 544 and 565, which are respectively illustrated in FIGS. 5a to 5d. Bulletin data is registered in the step 405 and it is determined whether or not a criterion for closing the bulletin board has been satisfied (step 406). As aforementioned, the criterion for closing the bulletin board may generally comprise information on the number of bulletin data or an expiration date of the corresponding bulletin board that the bulletin board establisher has input when opening the bulletin board. In case that the number of bulletin data reaches a predetermined value by bulletin data registered in the step 405, operation of the bulletin board ends (step 407). In case that it is determined that the criterion for closing the bulletin board is unsatisfied in the step 406, the bulletin board management system operates so that predetermined bulletin data may be Input by the bulletin board user by returning to the step 401.

When operation of the bulletin board ends in the step 407, bulletin board information is transmitted to a bulletin board operator (step 408), wherein the bulletin board information includes at least one bulletin data, subject data, and information on bulletin board users including the bulletin board establisher. The bulletin board operator inspects bulletin material information of the closed bulletin board by receiving the same (step 409). As aforementioned in FIG. 1, the bulletin board operator is an entity who manages the bulletin board according to the present invention. Therefore, the bulletin board operator may be located inside the bulletin board management system according to the present invention or manage the bulletin board via a predetermined communication network by locating oneself in a remote location of the bulletin board management system. The bulletin board operator determines whether or not the closed bulletin board satisfies the predetermined criterion for closing thereof, based on the result of inspection (step 410) and approves application for closing the bulletin boad. The bulletin board operator's inspection performed in steps 409 and 410 is performed, based on 1) adequacy of bulletin data or 2) on whether or not the bulletin board deserves to be stored in the bulletin board database, as one knowledge bulletin board after a closing of the bulletin board. Il addition, the inspection may be performed, based on that the system inspection performed in steps FIGS. 5a to 5d has been performed correctly. In case that the closing of the bulletin board is disapproved in the step 410, i.e. in case that the system operator determines that some bulletin data is inadequate, the bulletin board operator can delete the corresponding bulletin data (step 413) and reopen the bulletin board so that bulletin data may be registered as many as the number of deleted bulletin data. In case that the bulletin board operator approves the closing of the bulletin board in the step 410, the bulletin board management system notifies bulletin board users including the bulletin board establisher, of the event that the bulletin board has been closed via an e-mail or SMS (step 411) and records the corresponding bulletin board information in the bulletin board database (step 412).

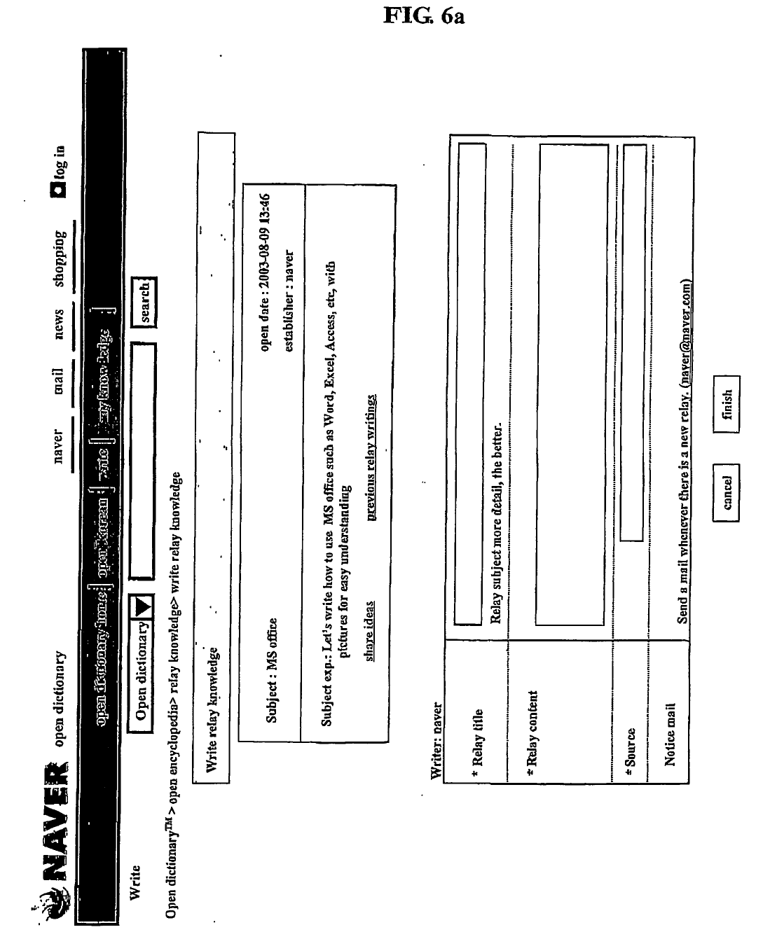

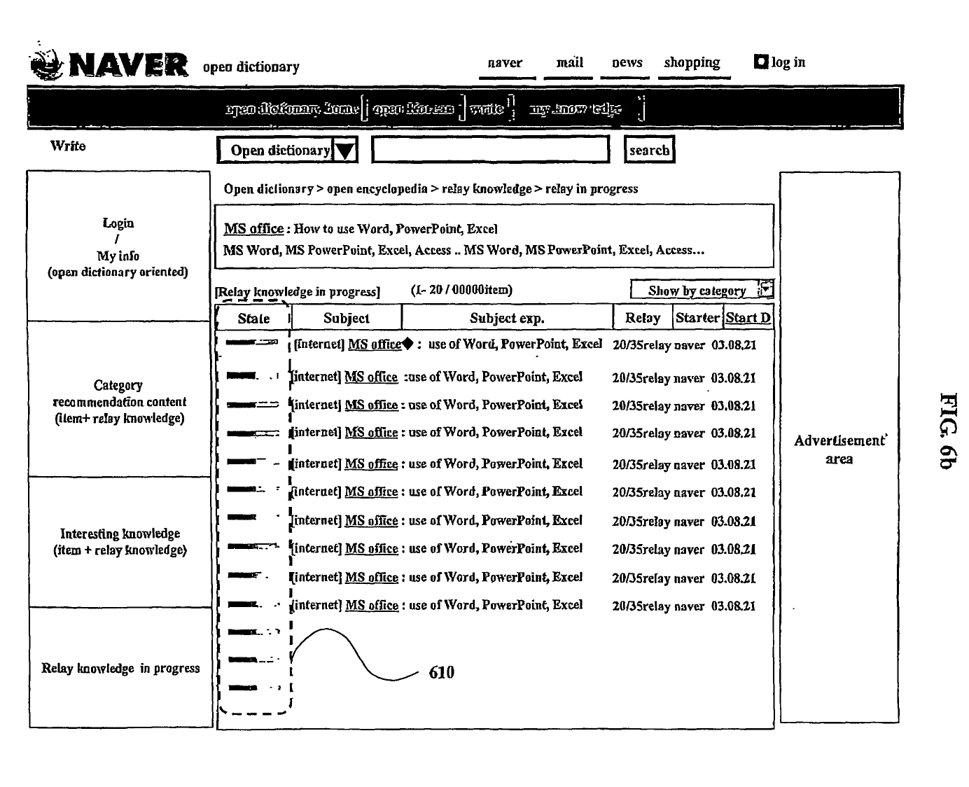

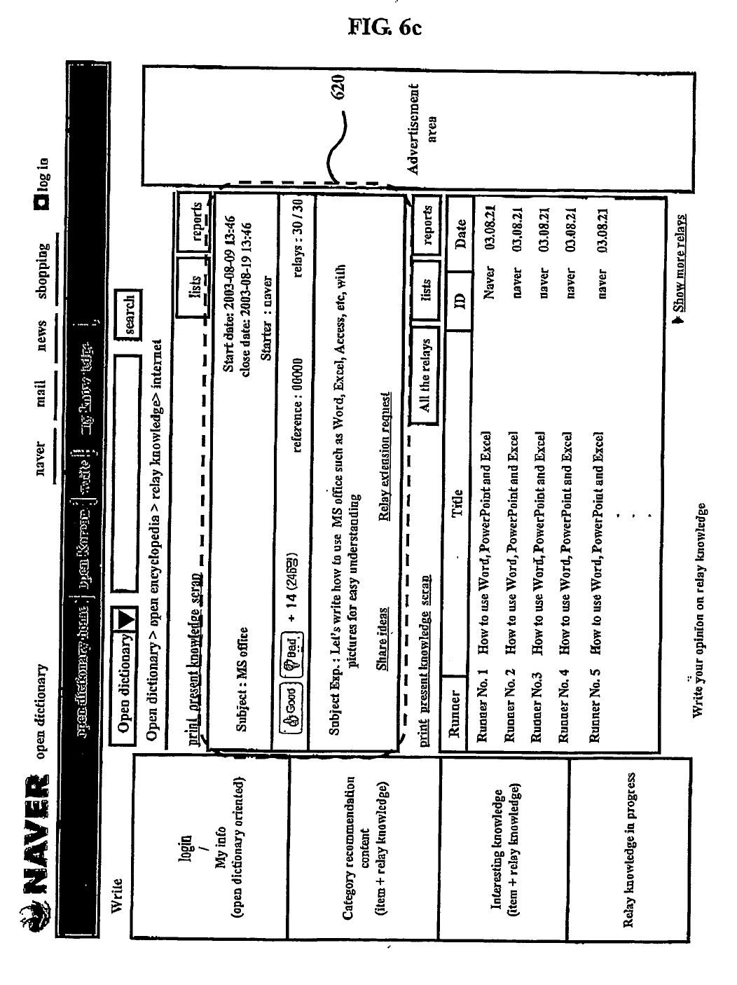

FIGS. 6a to 6c are drawings illustrating one example of a user interface which may be adopted in a method for operating a bulletin board on the Internet according to one embodiment of the present invention.

FIG. 6a is one example of a user interface provided for the bulletin board user in order to receive bulletin data on the bulletin board according to the present invention, wherein the user interface is provided for the bulletin board user. Referring to FIG. 6a, bulletin data may include title data of bulletin material, text data thereof, source information thereof or the like.

FIG. 6b is one example of a user interface for providing information on a progress state of the bulletin board according to the present invention, for users who use the bulletin board according to the present invention. Referring to FIG. 6b, information of the bulletin board belonging to a predetermined title (e.g., “MS office”) is provided. Especially, a progress state of the corresponding bulletin board is visually displayed as a form of bar, in an area 610 of displaying a current state of relays. According to embodiments, with click of the area 610, it is possible to concretely indicate the progress state of the corresponding bulletin board as a form of track.

FIG 6c is one example of a user interface for informing users who use the bulletin board according to the present invention that the bulletin board user's inspection is in progress with respect to the bulletin board according to the present invention. Referring to FIG. 6c, bibliographic information (subject data, opened date and closing date, establisher information, the number of bulletin data, etc) is displayed on an area 620. At this time, a message is displayed that “the bulletin board is closed and under inspection now”. As illustrated in FIG. 6c, even in case that the bulletin board is in the step of inspection by the bulletin board operator, it may be possible to read bulletin data input by bulletin board users,

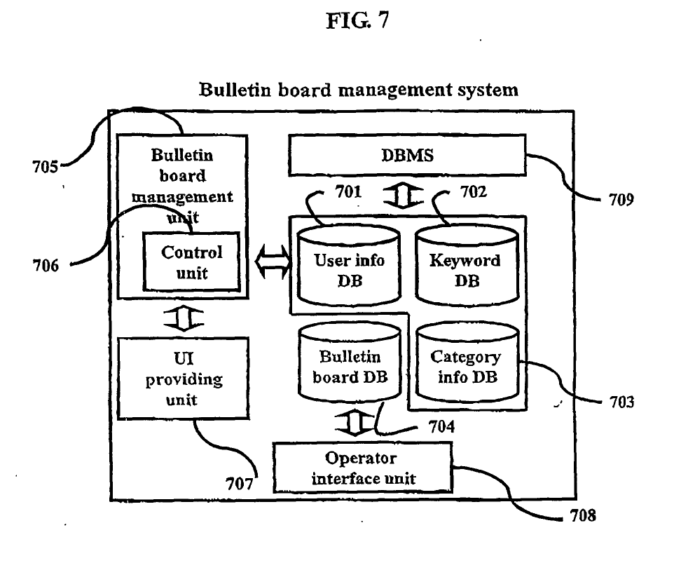

FIG. 7 is a block diagram illustrating configuration of a system for managing the bulletin board on the Internet according to one embodiment of the present invention.

Referring to FIG. 7, the bulletin board management system according to the present invention comprises a user information database 701, a keyword database 702, a category information database 703, a bulletin board database 704, a bulletin board management unit 705 including a control unit 706, a user interface providing unit 707, an operator interface unit 708 and a database management unit 709.

The user information database 701 stores information on a bulletin board user (a user ID, field of interest, or contact information) or point information given to the bulletin board user according to a predetermined criterion. The keyword database 702 stores a predetermined record-prohibited keyword which is prohibited from being included in subject data or bulletin data. An example of the record-prohibited keyword includes a keyword related to an abuse, adult things, or advertisement. In addition, the keyword database 702 may continuously update the record-prohibited keyword lice above.

The category information database 703 stores predetermined category information and keywords which belong to Me relevant category. For example, the category information database 703 stores both category information such as “law, legislation>intellectual property>patent” and keywords related thereto (patent, patent office, patent attorney, utility, trademark, examiner, etc). Therefore, in case that subject data is input by the bulletin board establisher, the bulletin board management system recommends related keywords automatically by searching the category information database 703. The aforementioned user information database 701, keyword database 702 and category information database 703 may be comprised in the bulletin board management system according to the present invention or another database which is adopted in other knowledge search service system.

The bulletin board database 704 stores bulletin board information such as application data of the bulletin board, bulletin data, and the like. According to one embodiment of the present invention, the bulletin board database 704 may consist of at least one sub database. First, the bulletin board database 704 may be embodied as a first bulletin board database for recording bulletin board information on the bulletin board currently in progress and a second bulletin board database for recording bulletin board information on the expired bulletin board, or may be embodied including a subject application database of the bulletin board in order to manage the application data of the bulletin board separately.

The bulletin board management unit 705 performs processing of registration or deletion of the input application data or bulletin data according to a predetermined criterion. The bulletin board management unit 705 may perform functions of analyzing the input application data from the bulletin board establisher and inspecting the same systematically. The control unit 706 included in the bulletin board management unit 705 controls general operations of the bulletin board management system according to the present invention. In addition, the control unit 706 controls the user interface providing unit, which will be described later. The control unit 706 may control the user interface corresponding to input of the bulletin board user, to be provided for the bulletin board user.

The user interface providing unit 707 provides bulletin board users with the user interface for receiving the application data or bulletin data from at least one bulletin user including the bulletin board establisher. Moreover, in case that the input data satisfies a predetermined condition, the user interface providing unit 707 provides a bulletin board user with a message informing that registration of bulletin data is prohibited or the like.

The operator interface unit 708 is for transmitting bulletin board information including the input bulletin application data or bulletin data to a system operator, and receiving approval of application with respect to the application data and approval of completion with respect to bulletin board information from the system operator.

The bulletin board management unit 709 is for managing the user information database 701, the keyword database 702, the category information database 703 and the bulletin board database 704 Therefore, the bulletin board management unit 709 may be embodied for the purpose of the present invention, using Relational Database Management Systems (RDBMS) such as Oracle, Infomix, Sybase and DB2 or Object-Oriented Database Management systems (ODBMS) such as Orion and O2.

In addition, embodiments of the present intention further relate to computer readable media that include program instructions for performing various computer-implemented operations. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as floptical disks; and hardware devices that are specially configured to store and perform program. instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter,

### INDUSTRIAL APPLICABILITY

According to the present invention, there is an effect that it is possible to complete contents of knowledge through a plurality of users' cooperation, not one user's knowledge, by enabling at least one bulletin board user to unite in inputting contents of knowledge on a specified subject.

Further, according to the present invention, there is an effect that it is possible to provide a new knowledge search service method which enables a plurality of users to read knowledge data, wherein one knowledge data is built by helping a plurality of bulletin board users to input bulletin data with respect to one subject and stored in a database.

Furthermore, according to the present invention, there is an effect that it is possible to provide, a knowledge search service on various fields by inducing a new category based on a user, not classification of categories which is provided by a conventional knowledge search service.

Like above, although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention.

1. A method for generating a bulletin board on the Internet, the method comprising the steps of:
maintaining a bulletin board database storing at least one bulletin data which at least one user has input on the unitary subject;
providing a user interface for receiving data required to open the bulletin board, for an establisher, a user who wants to open the bulletin board;
receiving application data of the bulletin board from the establisher; transmitting the received application data to a bulletin board operator;
notifying the establisher that the bulletin board has been generated in accordance with approval of the bulletin board operator; and
recording the application data for the generated bulletin board in the bulletin board database;
wherein the application data comprises at least one selected from a group consisting of subject data of the bulletin board, information on the number of the bulletin data which is possible to be registered on the bulletin board, and information on an expiration date of the bulletin board.

2. The method as claimed in claim 1, wherein the step of receiving the application data from the establisher comprises the steps of:
abstracting a predetermined character string from the subject data which is included in the received application data;
searching for subject data of the bulletin board corresponding to the abstracted character string by referring to the bulletin board database; and
providing the searched subject data for the establisher.

3. The method as claimed in claim 2, wherein the step of providing the searched subject data for the establisher comprises the steps of:
providing the establisher with a user interface for displaying current situation of the bulletin board corresponding to the searched subject data;
based on the current situation, in case that the bulletin board is being operated, receiving participation request data from the establisher and in case that the bulletin board is closed, receiving extension application data for the bulletin board from the establisher.

4. The method as claimed in claim 1, further comprising the step of:
maintaining category information database storing category information which is classified according to a predetermined criterion;
wherein the step of receiving the application data from the establisher comprises the steps of:
abstracting a predetermined character string from the subject data which is included in the received application data;
providing the establisher with category information corresponding to the abstracted character string, by searching for the category information database; and
recording the category information selected by the establisher in the bulletin board database.

5. The method as claimed in claim 1, further comprising the step of:
maintaining a user information database storing information on a bulletin board user, point information which is given to the bulletin board user based on a predetermined criterion, or information on a field of interest of the bulletin board user;
wherein the step of notifying the establisher that the bulletin board has been generated in accordance with approval of the bulletin board operator comprises the steps of:
searching for the bulletin board user whose point information exceeds a predetermined value, for information on the field of interest corresponding to the subject data, by referring to the user information database; and
providing the establisher with the information on the searched bulletin board user.

6. A method for operating a bulletin board generated by the method of claim 1, the method comprising the steps of:
receiving bulletin data related to subject data of the bulletin board from one or more bulletin board users including the establisher of the bulletin board;
determining whether or not the bulletin data may be registered by analyzing the same;
closing the bulletin board, based on a predetermined criterion, wherein the predetermined criterion is set based on information on the number of bulletin data which is possible to be registered on the bulletin board, or the expiration date of the bulletin board that the establisher has input when the bulletin board is generated;
transmitting bulletin material information, including the bulletin data of the closed bulletin board, to the bulletin board operator;
notifying the establisher that the bulletin board has been completed in accordance with approval of the bulletin board operator; and
recording the bulletin material information on the closed bulletin board in the bulletin board database.

7. The method as claimed in claim in 6, wherein the bulletin board database further stores information on progress state of the bulletin board, and the method further comprises the steps of:
updating the information on progress state of the bulletin board, stored in the bulletin board database, corresponding to the input of the bulletin data; and providing the bulletin board users with the user interface displaying the updated information on progress state of the bulletin board.

8. The method as claimed in claim 6, further comprising the step of maintaining a user information database storing a user ID for the one or more bulletin board users who input the bulletin data;
wherein the step of determining whether or not the bulletin data may be registered by analyzing the same comprises the steps of:
searching for a user ID of a first bulletin board user who has input the bulletin data, by referring to the user information database;
determining whether or not the searched user ID of the first bulletin board user is identical to a user ID of a second bulletin board user who had input bulletin data previously; and
in case that it is determined that the searched user ID of the first bulletin board user is identical to the user ID of the second bulletin board user, providing the first bulletin board user with a user interface including the content that registration of the bulletin data is prohibited.

9. The method as claimed in claim 6, further comprising the step of:
maintaining a user information database storing the information on the bulletin board user or predetermined point information given to the bulletin board user based on the predetermined criterion;
wherein the step of determining whether or not the received bulletin data may be registered by analyzing the same comprises the steps of:
searching for the point information on the bulletin board user by referring to the user information database; and
in case that the searched point information is below the predetermined value, providing the bulletin board user with the user interface including the content that registration of the bulletin data is prohibited.

10. The method as claimed in claim 6, wherein the step of determining whether or not the received bulletin data may be registered by analyzing the same further comprises the steps of:
measuring the data size of the bulletin data;
determining whether or not the measured data size satisfies the predetermined size condition, wherein the predetermined size condition includes the maximum value or minimum value of the data size; and
in case that the size condition is unsatisfied with the data size, providing the user with the user interface including the content that registration of the bulletin data is prohibited.

11. The method as claimed in claim 6, further comprising the step of:
maintaining a keyword database storing a predetermined record-prohibited keyword;
wherein the step of determining or not whether the received bulletin data may be registered by analyzing the same comprises the steps of:
abstracting a character string for the received bulletin data;
determining whether or not any record-prohibited keyword corresponding to the abstracted character string is stored in the keyword database by referring thereto; and
in case that it is determined that the record-prohibited keyword corresponding to the abstracted character string is stored, providing the user with the predetermined user interface displaying a predetermined process for the received bulletin data, wherein the predetermined process is any one between automatic deletion of the bulletin data and correction request of the bulletin data.

12. The method as claimed in claim 6, wherein the step of transmitting the bulletin material information, including the bulletin data of the closed bulletin board, to the bulletin board operator comprises the steps of:
receiving information of the deletion request of the bulletin data from the bulletin board operator; and
in case that the bulletin data of the bulletin board has been deleted due to the received information of the deletion request, controlling the bulletin board to be reopened for the number of deleted bulletin data.

13. The method as claimed in claim 6, wherein the step of closing the bulletin board, based on the predetermined criterion, comprises the steps of:
receiving extension application data of the bulletin board from the bulletin board user;
transmitting the received extension application data to the bulletin board operator; and
controlling the bulletin board to be reopened in accordance with approval of the bulletin board operator.

14. The method as claimed in claim 6, further comprising the step of:
maintaining the user information database storing contact information on at least one bulletin board user;
wherein the step of closing the bulletin board, based on the predetermined criterion, comprises the steps of:
searching for the contact information on the bulletin board user by referring to the user information database; and
notifying the bulletin board user that the operation management of the bulletin board has been ended via the user's e-mail address or SMS through the user's mobile communication device, based on the searched contact information.

15. The method as claimed in claim 6, further comprising the step of:
maintaining a user information database storing information on the bulletin board user or the predetermined point information given to the bulletin board user based on the predetermined criterion;
wherein the step of receiving bulletin data related to subject data of the bulletin board from one or more bulletin board users comprises the step of:
increasing the user's point information, stored in the user information database, by the predetermined value.

16. The method as claimed in claim 6, further comprising the steps of:
maintaining the user information database storing information on the bulletin board user or the predetermined point information given to the bulletin board user based on the predetermined criterion; and
increasing the point information on the one or more bulletin board users by the predetermined value.

17. A computer readable record medium recording a program for implementing the method of claim 1.

18. A system for managing a bulletin board on the Internet, the system comprising:
a user interface providing unit for providing a user interface used for receiving application data of the bulletin board or bulletin data from at least one bulletin board user including the bulletin board establisher;
a user information database for storing at least one selected from a group consisting of a user ID of at least one bulletin board user, point information given thereto, and contact information thereof;
a bulletin board database for storing information on the bulletin material including at least one bulletin data that at least one bulletin board user has input on the unitary subject;
a bulletin board management unit for registering or deleting the received application data or the bulletin data, based on the predetermined criterion;
an operator interface unit for transmitting bulletin board information including the received application data or the bulletin data to a system operator and receiving a predetermined response therefrom; and
a database management unit for managing the user information database or the bulletin board database.
